(19) United States
(12) Patent Application Publication
(10) Pub. No.: US 2021/0092483 A1
(43) Pub. Date: Mar. 25, 2021

(54) System and Method for Converting Screens into Remotely Controlled Terminals

(71) Applicant: SHAWN L. BOWMAN, DYER, IN (US)

(72) Inventor: SHAWN L. BOWMAN, DYER, IN (US)

(21) Appl. No.: 16/579,417

(22) Filed: Sep. 23, 2019

(51) Int. Cl. H04N 21/458; G06F 3/14; H04N 21/4227; H04N 21/41; H04N 21/4363; H04N 21/442

(52) U.S. Cl. CPC H04N 21/458; G06F 3/1454; H04N 21/44245; H04N 21/4126; H04N 21/43635; H04N 21/4227

(57) ABSTRACT

A system and method for converting conventional screens, televisions and monitors into content terminals is disclosed. The invention being comprised of three main parts: a first part being software; a second part being a peripheral, plugin device or a standalone computer; and a third part being a cloud network. Said plug-in device having an HDMI port allowing it to connect to the majority of conventional screens as well as a microcontroller with onboard memory and wireless receiver to obtain signals from said cloud network, or a hard wired internet connection. The invention allowing users to create content and content sequences (such as public information, commercials, interactive content and advertisements etc.) on the server that is then sent to the plugin device at the time the user selects in their scheduling which in turn obtains control over the screen and displays the content thereon. Other features also include, but are not limited to: scheduling content broadcasts, status notifications and mobile app compatibilities. An object of the invention is to convert any screen into a customizable, independent content terminal without the need for a computer and is controllable through the app or the dashboard from anywhere with an internet connection.

### FIELD OF THE INVENTION

The present invention generally relates to low bandwidth digital sign control software. More specifically, it relates to software that resides on a remote peripheral, plugin device or on a remote computer that when connected to any television or monitor (or similar) screen can control said screen's content remotely without the need for constant streaming.

### BACKGROUND

Digital signage systems can be used in a multitude of fashions; to display advertising, communicate corporate information, showcase presentations, create interactive kiosks, create trade show booths and display machine and/or production data. Monitor and/or Television screens are most commonly utilized to present this information as digital signage. Today's monitors and televisions usually require a High-Definition Multimedia Interface (HDMI) port as a way to receive and display images, uncompressed video, interactive content and digital audio data. Because such screens are lightweight, versatile, inexpensive and extremely thin, they are now replacing indoor and outdoor traditional signage and billboards on roadways, in large indoor spaces such as stadiums and airports and from retail to tradeshow to corporate displays. Some in the signage industry have begun programming the screens with digital content using the HDMI ports. United States Patent No. US20140040031A1 granted to Jonathan Christian Frangakis and Gabriel Alan Frangakis disclosed a system that uses an HDMI plugin device to turn conventional screens into advertisement displays; however, it relies on a constant connection with a remote server and therefore detracts from a user's precious bandwidth. U.S. Pat. No. 9,619,808B2 granted to Doug Bannister, Andrew Collard, Doug Underwood, Nick Easthope, Scott Kayes, Rick Dalley and William Chu disclosed a system to control multiple screens through a network but does not incorporate independent devices on the HDMI port. Conventional digital signage typically either streams data, which sacrifices network bandwidth, or is hard programmed, which requires a sign administrator to be physically present at the screen location to modify content.

United States Patent No. US20130031128A1 granted to Michael A. Provencher, Kent E. Biggs, and Robert Joseph Rosenberry disclosed a central repository for digital signs; however, it also does not include independent devices on the HDMI port. International Patent No. WO2015020695A1 granted to Nanxi LIU, David Zhu, David A. Ross, Zach SPITULSKI and Navdeep REDDY disclosed a centralized system for digital advertising on display screens based on social media trends but does not include independent hosting at each screen. United States Patent No U.S. Pat. No. 8,786,459B1 granted to Hsiao Wey Nieh disclosed a connection device for screens to monitor existing digital advertising activity and status but does not automate the content delivery process. International Patent No. WO2016034099A1 granted to Chen Nianzu and Zhang Zhengyi disclosed a network system for linking screen displays it relies on networked signals and not a standalone HDMI device. United States Patent No. US20120114336A1 granted to Dongwook Kim, Agnihotri Tanmay and Ron Diaz disclosed a digital signage system that retrieves content from a remote server but also does not allow for local, HDMI port control.

### SUMMARY OF THE INVENTION

The device herein disclosed and described provides a solution to the shortcomings in the prior art through the disclosure of a system and method for a.) converting conventional screens into low-bandwidth remotely controlled content terminals without the need for a computer or b.) Converting a computer into low-bandwidth remotely controlled content terminal. An object of the invention is to allow any screen or monitor having an HDMI port to display content. The invention may include a portable device with software that plugs into a screen's HDMI port and controls content on the screen or may be a standalone computer with a display screen.

Another object of the invention is to provide a means to allow users to create, design and layout custom content to be utilized their screens. The invention includes a website portal on cloud network wherein users can login and use specialized, proprietary, graphics software to generate images, graphics and messages that can be uploaded to their HDMI devices instantaneously.

Another object of this invention is to allow users to schedule content on their screens. Content may be scheduled via a website portal on cloud network wherein users can login and use specialized, proprietary, scheduling software to select groups of images, videos and interactive content to be displayed at certain times and for certain durations. In addition, said software will accommodate for local time zones and download content required ahead of time to deploy the scheduled content on time. For example, once a user generates content in the cloud, they can then use the software to schedule when the content is displayed on screen. This information is then downloaded by the software to the device along with the content. The invention will then remove old content and display new content according to the preselected date and time. In addition, users can even program different content repeatedly to be displayed over days, months and years according to their scheduling preference.

Another object of this invention is to allow users to insert interactive content to their touch-enabled screens. Adding this content type will allow a viewer to not only view content, but interact with it as well.

Another object of this invention is to allow users to create and organize multiple “timelines” for their screens. Timelines can be combinations of files such as videos, touch screen content, images, graphics, audio files, commercials, syndicated downloadable content, etc.

Another object of the aforementioned invention is to provide a means to allow users to preserve expensive bandwidth. Similar devices rely on constant streaming connections to the Internet and can compete for network bandwidth. One or multiple streaming devices on a network can slow internet speeds for the whole network significantly. The device in this invention is WiFi enabled and does not need to use an Ethernet connection (but it can be incorporated if no WiFi is available). In addition, the software and devices can receive intermittent internet connectivity and still be functional. Since the device does not depend on streaming data in order to save a user's bandwidth, not only will the screen be functional during internet outages, but when the internet is available the software will have the device connect to the cloud server again to make sure upcoming scheduled content is accommodated.

Another object of the aforementioned invention is to provide a means to allow content to remain on screens if a user's Internet connection becomes inadvertently interrupted or unavailable. Content for the screens resides on local memory inside the plug-in device itself and does not rely on streaming content from remote storage servers on the Internet. Synchronization of scheduled content will be updated through the sever once an internet connection becomes available.

Another object of the aforementioned invention is to provide a means to allow users to manage their subscription and screen content on a mobile device such as a cell phone or tablet. A mobile device app is included as part of the software.

Another object of the aforementioned invention is to provide a means to allow users to configure WiFi and other settings by connecting via Bluetooth™ to the device on a mobile device such as a cell phone, laptop or tablet. A mobile device app is included as part of the software.

Another object of the aforementioned invention is a component of the software that routinely checks for software updates and installs them automatically as they become available in a way as to not interrupt the scheduled content. Thus, every device is constantly running on the same updated version of the software.

Another object of the invention is to provide a means to control multiple screens. The plug-in device also includes a capability allowing it to communicate with other plug-in devices within proximity and share content data across multiple screens.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows a perspective view of the invention and a conventional screen.

FIG. 2 illustrates a representative view of the invention process.

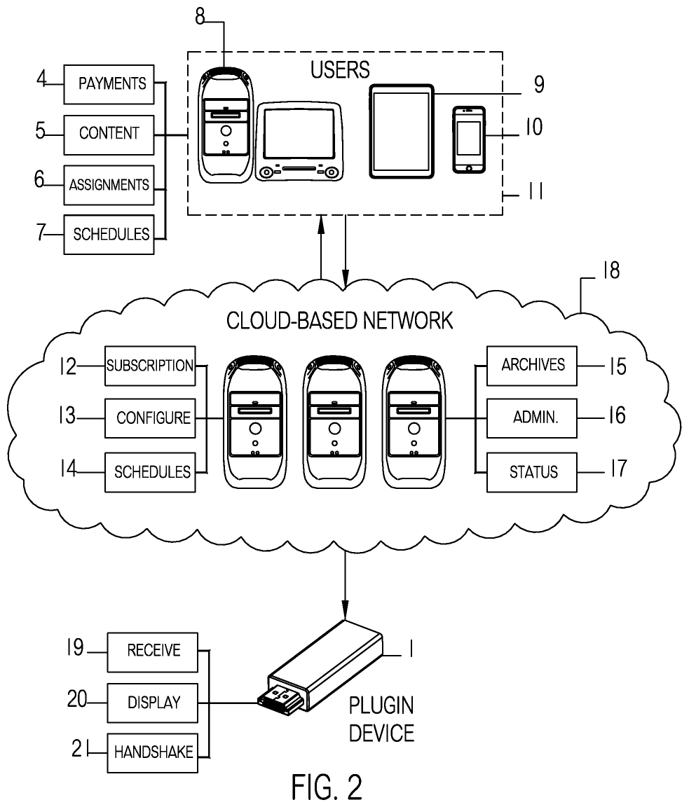

Other aspects of the present invention shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation. Conventional components of the invention are elements that are well-known in the prior art and will not be discussed in detail for this disclosure.

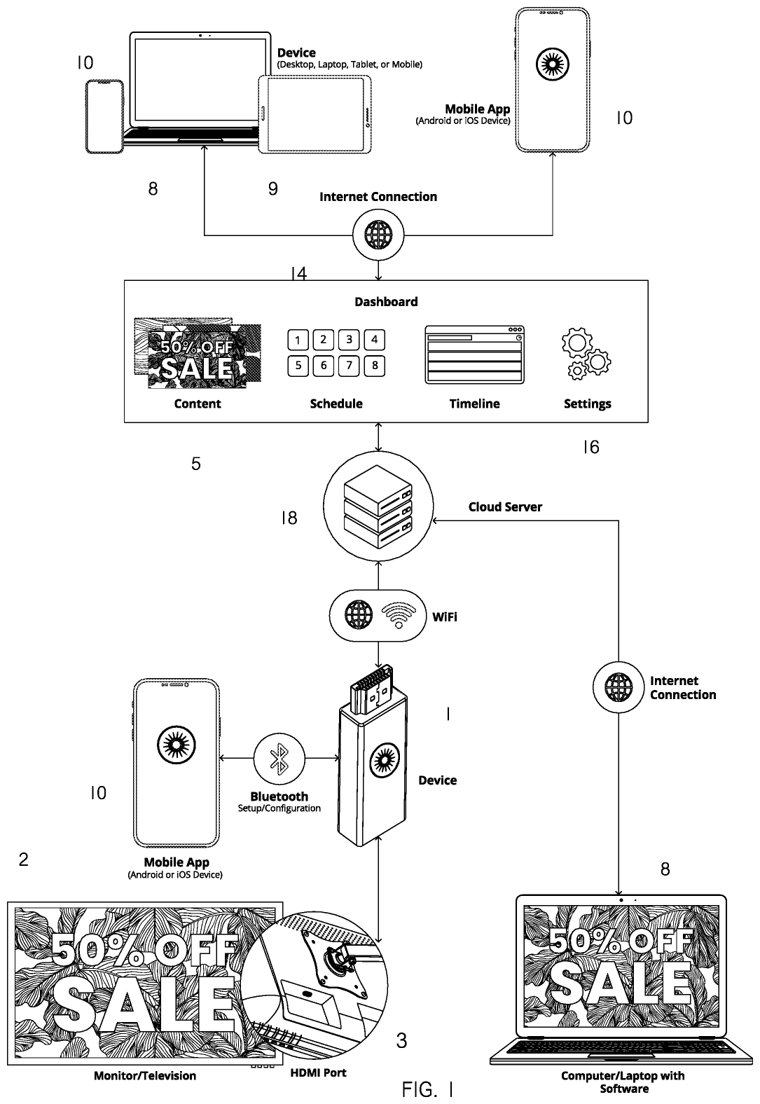

FIG. 1 showing perspective views of a preferred embodiment of the invention's plugin device 1 being comprised of a microcontroller having elements such as, but not limited to: an onboard memory (to maintain software); a Bluetooth™ unit; a WiFi receiver and a 4k HDMI coupler thereon. Said HDMI coupler being compatible with conventional HDMI port 3 on a typical monitors and screens including but not limited to: televisions 2; computers; laptop computers 8, smartphones 10 and the like. Said software on the plugin device 1 being written from code that may include, but not be limited to: Java, C++™, Visual Basic™, Linux™, Basic™ etc. and having a user interface that includes but is not limited to graphical content 5, options for scheduling 14 with timeline interface, and user settings 16. The software also compatible with a plurality of operating systems such as, but not limited to: Windows™, Apple™, and Android™, and compatible with a multitude of hardware platforms such as, but not limited to: personal desktops, laptops, tablets, smartphones and the like.

FIG. 3 illustrates a representative view of the invention process with users having access to functions including but not limited to: making online payments 4 to the subscription service; creating content 5 display on their chosen screens (digital multimedia graphics, video and audio etc.); assigning content 6 to specific screens and organizing various available screens at different locales; and scheduling content broadcasts 7 (by date, time, and location). Users also having the option of accessing the invention software by means of but not limited to desktop computers 8, tablets 9, laptops and smart phones 10 and the like. The cloud-based network 18 interacting with said user devices and having algorithms performing functions such as but not limited to managing user subscriptions 12 (online payments, levels of service etc.); pairing and configuring screen types and multimedia content with plug-in devices 13; scheduling plug-in device 1 broadcasts 14; archiving and organizing multimedia broadcasts for future use 15; administrative management (passwords, user access) 16 and broadcasts/device status 17. FIG. 3 also showing cloud network 18 interacting with plug-in device 1 by means of WiFi and receiving said signals 19; displaying broadcasts to selected screens 20 and handshaking with other plug-in devices 1 by means of Bluetooth™.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention.

What is claimed is:

1. A system for converting screens into advertising, display or interactive multimedia content terminals comprised of the following parts:
a) a software program recorded on a computer-readable plugin device for displaying advertisements and/or display content;
b) a cloud network for hosting a website, creating content, storing content, scheduling content and transferring content to the software program;
c) a plugin device for storing the program, connecting to screens and transferring content received from the cloud network; and
d) a mobile device application for configuration, content creation, schedule adjustments and uploading.

2. The system for converting screens into advertising, display or interactive multimedia content terminals of claim 1 wherein the software program transferring multimedia content from a server to the plugin device.

3. The system for converting screens into advertising content terminals of claim 1 wherein the plugin device having an HDMI coupling, microcontroller, onboard memory, WiFi receiver and Bluetooth communications.

4. The system for converting screens into advertising, display or interactive multimedia content terminals of claim 1 wherein the plugin device receives content and content schedules from the cloud network.

5. The system for converting screens into advertising, display or interactive multimedia content terminals of claim 1 wherein the cloud network having operations that include scheduling locations and timing of content broadcasts (called Timelines), managing subscriptions, and archiving multimedia content.

6. A method for converting screens into advertising, interactive or display content terminals, the method is comprised of the following steps:
a) creating multimedia or interactive content for advertising, interactive or display purposes;
b) scheduling content for screens at different time frames and intervals;
c) optionally either remotely loading content to a plugin device remotely using the cloud network or loading content to a remote computer using the cloud network;
d) controlling content on single or multiple display terminals at once remotely; and
e) installing a plugin device into a screen's input port;

7. The method for converting screens into advertising, display and interactive content terminals of claim 6 wherein the creating multimedia content for advertising or display purposes is generated on the cloud network of claim 1.

8. The method for converting screens into advertising content terminals of claim 6 wherein the scheduling multimedia and/or interactive content for screens at different time frames is performed on the cloud network of claim 1.
